(19) United States
(12) Patent Application Publication
(10) Pub. No.: US 2007/0148390 A1
(43) Pub. Date: Jun. 28, 2007

(54) Fluorinated coatings

(75) Inventor: Rakesh Kumar, Carmel, IN (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Specialty Coating Systems, Inc., Indianapolis, IN (US)

(21) Appl. No.: 11/318,920

(22) Filed: Dec. 27, 2005

(51) Int. Cl. B32B 1/08

(52) U.S. Cl. 428/36.91

(57) ABSTRACT

Conformal coatings are disclosed. A fluorinated thin film, for example, is formed by vapor phase polymerization on a variety of sensitive surfaces that may include electronic and automotive sensors, biochips, implantable sensors and biomedical devices.

### BACKGROUND OF INVENTION

1. Field of Invention

The present invention relates to coatings and, more specifically, to thin films on a variety of surfaces of articles such as electronic and automotive sensors, biochips, implantable sensors, and other biomedical devices.

2. Discussion of Related Art

The beneficial physical properties of the parylene polymer family make it an ideal choice for use as a coating in a variety of applications. Methods for the preparation of such coatings are known. For example, in U.S. Pat. No. 5,424,097, Olson et al. disclose a continuous vapor deposition apparatus for coating objects with a coating material such as parylene. Also, in U.S. Pat. No. 5,536,892, Dolbier, Jr. et al. disclose processes for the preparation of octafluoro-[2,2]paracyclophane.

### SUMMARY OF THE INVENTION

In accordance with one or more embodiments, the invention relates to a coating on at least a portion of at least one surface of an article, comprising at least one layer of a polymeric film of 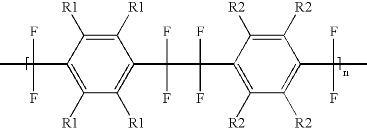
having a thickness in a range from about 500 Å to about 25 μm, where n is at least 2 and R1 and R2 are at least one of a halogen and hydrogen. The article may be, for example, an electronic device or implantable medical device.

In accordance with one or more embodiments, the invention relates to a method of coating a surface of an article comprising vaporizing a fluorinated paracyclophane dimer to produce a vaporized monomeric species, and polymerizing the monomeric species on at least a portion of the surface to produce a conformal coating comprising a polymeric material having a thickness in a range from about 500 Å to about 25 μm, the polymeric material having a formula 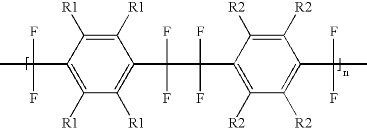
where n is at least 2 and R1 and R2 comprise hydrogen or a halogen. The fluorinated paracyclophane dimer can be selected from the group consisting of octofluoro-[2,2]-paraxylylene and perfluoro-[2,2]-paraxylylene. The article can comprise, for example, a nanoscale structure or an electronic device.

### BRIEF DESCRIPTION OF THE DRAWINGS

The accompanying drawing is not intended to be drawn to scale. For purposes of clarity, not every component may be labeled. Preferred, non-limiting embodiments of the present invention will be described with reference to the accompanying drawing, in which:

FIG. 1 illustrates a coated article in accordance with one or more embodiments of the invention.

### DETAILED DESCRIPTION

In accordance with one or more embodiments, the invention relates to coatings that may serve as, for example, protective, conformal, and/or functional coatings, in a range of thickness. This invention is not limited in its application to the details of construction and the arrangement of components as set forth in the following description or illustrated in the drawing. The invention is capable of embodiments and of being practiced or carried out in various ways beyond those exemplarily presented herein.

One or more aspects of the invention can be directed to a coating on an article. The article can be any desired article including, for example, electronic and automotive sensors, biochips, implantable sensors as well as other articles that may benefit from utilization of the applied coatings of the invention such as, but not limited to, biomedical devices. The invention may be practiced utilizing the techniques, or a combination thereof, described herein. Other techniques may also be utilized to effect one or more features and/or advantages of the invention. However, some aspects of the invention may be particularly effected by utilizing the techniques described herein. For example, deposition of fluorinated polymeric coatings on articles in the nano, or even micro, scale may require depositing precursor species that polymerize into the polymeric materials of the invention.

Some aspects of the invention directed to deposition of a fluorinated species, the invention may further involve aspects directed to molecular deposition techniques of precursor species that form or at least facilitate formation of a polymeric material, preferably as a layer or coating on a surface. Indeed, some aspects of the invention may be directed to providing and/or depositing a level, even, or uniform polymeric material, preferably, fluorinated, in a plurality of dimensions, e.g., three-dimensionally. The components, systems, and/or techniques of the invention advantageously provide uniformly thick coatings on surfaces of articles that have features, protrusions and/or depressions to the extent not previously disclosed. In accordance with some aspects of the invention, the techniques directed to vapor phase deposition to provide fluorinated polymeric materials provide thinner and/or more uniform coatings compared to techniques that involve solution or carrier other based deposition/polymerization techniques.

In accordance with some aspects, the invention can be directed to methods or techniques of coating at least a portion of a surface of an article. The method can, in accordance with some embodiments pertinent to this aspect of the invention, be characterized as providing a controlled rate of deposition of a coating to a predetermined thickness. One or more layers can be deposited to produce a coating in a thickness range of about 500 Å to about 25 μm. Preferably, the resulting coating is defect-free, or has a tolerable amount of defects. For example, the coating is preferably pinhole-free. In some case, the coating further possesses or provides desirable dielectric and barrier properties, and, in some cases, can also exhibit chemical and/or biological inertness. Thicker coatings typically do not provide additional advantages and thinner coating may result is defects such as regions with insufficient or no polymeric deposits.

Thus, in accordance with some aspects, the present invention can thus provide components, systems, and/or techniques that overcome limitations inherent with solution based deposition. The techniques of the present invention can avoid limitations associated with wetting surfaces of articles upon which the polymeric material is deposited by molecularly depositing precursors, or derivatives thereof, of polymeric materials forming the coating. Such features can thereby allow uniform coating of surfaces of articles that are internal, not directly exposed, or at least partially obstructed. An internally disposed surface of an article may thus be coated provided such surface is communicable with a source of a vaporized precursor material, or derivatives thereof.

The method can be used to coat the entire surface of an article or only a portion thereof. The article to be coated by the described method may be, for example, a nanoscale structure, electronic device or any other sensitive surface.

Techniques directed to disposing the polymeric coating can, for example, involve steps or acts of vaporizing the one or more precursor materials, which can include, for example, solid and/or liquid dimers. Vaporizing or sublimating can be effected by heating the one or more precursor dimers at a temperature in a range of about 120° C. to about 200° C. Cleavage of the dimer can then be effected by exposure thereof to a sufficient temperature, typically a temperature in a range from about 500° C. to about 700° C., to yield one or more monomeric diradical species, e.g., paraxylylene. Cleavage or pyrolysis can be effected in, for example, a pyrolysis tube. Deposition of the one or more monomeric diradical species can then be effected in, for example, a deposition chamber having one or more articles to be coated. The deposition act can be performed at about room temperature. It is believed that the monomeric diradical species polymerizes as it is adsorbed on the deposition surface thereby providing a coating having uniform properties. Such coatings can thus be uniformly disposed on a three-dimensional surface.

The deposition technique typically does not involve a liquid phase and the substrate surface temperature does not substantially increase above ambient temperature, e.g. it remains at about room temperature. In some embodiments of the invention, deposition acts is performed under a vacuum pressure, e.g., less than atmospheric pressure.

In accordance with one or more aspects of the invention, a fluorinated paracyclophane dimer can be vaporized to produce the vaporized species. The fluorinated paracyclophane dimer can be, for example, octofluoro-[2,2]-paraxylylene and/or perfluoro-[2,2]-paraxylylene. The monomeric species can then be polymerized on the surface of an article to produce a conformal layer of the polymeric material having a formula 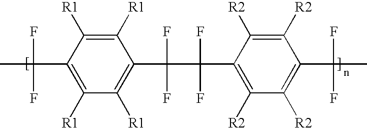
wherein n is at least 2 and each of R1 and R2 is either hydrogen or a halogen, such as fluorine. Thus, aspects of the invention can be directed to disposing a polymeric material on at least a portion of a surface of an article, without the use of a solvent or other carrier that facilitates motility of the polymeric precursor materials, or derivatives thereof. In accordance with particular embodiments of some aspects of the invention, the precursor materials are selected to be fluorinated dimmers that are vaporizable into monomeric species and deposit on the surface to produce a layer of a polymeric material in the nano-scale or angstrom-scale domain.

Further aspects of the invention provide molecularly depositing fluorinated monomeric or precursor species to produce fluorinated polymeric coatings.

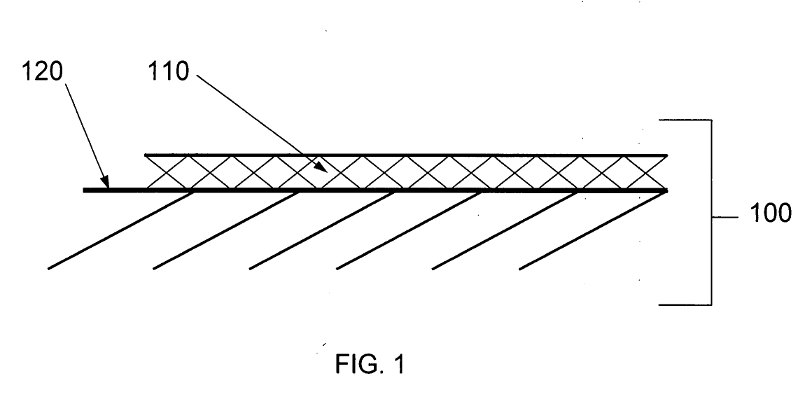

One or more embodiments of the invention can be directed to a coated article 100 as exemplarily shown in FIG. 1. Coating 110 can be applied to article surface 120. Coating 110 can comprise one or more layers applied by, for example, a vapor deposition polymerization process, involving a polymer. Thus, as noted one or more embodiments of the invention may be directed to protective and/or conformal coatings. For example, the polymer can comprise one or more members of the parylene family.

Any suitable precursor material may be utilized to provide the one or more coatings of the invention. Indeed, a combination of precursor compounds may be utilized to provide a co-polymeric coating. Further particular exemplary embodiments of the invention can be directed to one or more fluorinated paracyclophane dimers that can be vaporized to produce a vaporized monomeric species. The fluorinated paracyclophane dimer can be, for example, octofluoro-[2,2]-paraxylylene and/or perfluoro-[2,2]-paraxylylene. The monomeric species can then be polymerized on the surface of the article to produce a layer of the polymeric material having a formula 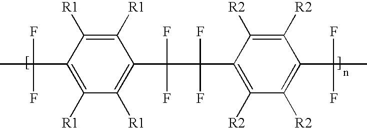
wherein n is at least 2 and R1 and R2 is either hydrogen or a halogen, such as fluorine. Coating 110 can be in a thickness range of about 500 Å to about 25 μm. and can cover or otherwise isolate the entire surface of the article 100 or a portion thereof.

Embodiments of the disclosed invention can find multiple uses in the field of electronics, including automotive applications. In applications where chemical inertness, high tensile and/or dielectric strength, conformality, low permeability, low mass and low mechanical stress are desirable, the coating disclosed herein advantageously provides features directed to, for example, protecting or rendering inert the substrate, and/or protecting or insulating the substrate from its environment during use, storage, and/or fabrication. For example, the polymeric materials can have a dielectric strength of about 4,000 to 5,000 volts/mil, typically about 5,400 volts/mil, as determined in accordance with ASTM D149 at room temperature. Other electrical properties of the polymeric material, such as dielectric constant, can be about 2 to about 3 as determined in accordance with ASTM D150 at room temperature, typically about 2.21 at about 60 Hz and about 2.20 at about 1 kHz.

The polymeric materials of the invention can have the physical properties listed in Table 1.

TABLE 1
Typical Properties

| Property | Value | Test Method/Condition |
|---|---|---|
| Dielectric Strength | 5,400 | ASTM D149 |
| (volts/mil) | | room temperature |
| Dielectric Constant, | | |
| 60 Hz | 2.21 | ASTM D150 room |
| 1 kHz | 2.2 | temperature |
| Dissipation Factor, | | |
| 60 Hz | 0.0002 | ASTM D150 |
| 1 kHz | 0.002 | room temperature |
| 1 MHz | 0.001 | |
| Volume Resistivity | 1.9 × 10¹⁷ | ASTM D257 |
| (ohm-cm) | | room temperature |
| | | 50% relative humidity |
| Surface Resistivity | 5 × 10¹⁵ | ASTM D257 |
| (ohms) | | room temperature |
| | | 50% relative humidity |
| Tensile Strength | 7,500 | ASTM D882 |
| (psi) | | 25° C. |
| | | 50% relative humidity |
| Modulus | 370,000 | ASTM D5026 |
| (psi) | | DMA |
| Elongation at Break | 10 | ASTM D882 |
| (%) | | 25° C |
| | | 50% relative humidity |
| Hardness, | | |
| Rockwell | R122 | ASTM D785 |
| Knoop | 19-22 | |
| Coefficient of Friction, | | |
| Static | 0.145 | ASTM D1894 |
| Dynamic | 0.13 | |
| Coefficient of Linear | 36 | TMA |
| Thermal Expansion | | room temperature |
| (μm/m° C.) | | |
| Specific Heat | 1.04 | ASTM E1461 |
| (J/g · K) | | room temperature |
| Thermal Stability | >450 | ASTM E1131 |
| (° C.) | | |
| Thermal Conductivity | 0.096 | ASTM E1461 |
| (W/m · K) | | room temperature |
| Outgassing, | | |
| Total Mass Loss (%) | 0.03 | ASTM D595 |
| Collected Volatile | 0.04 | 24 hours |
| Condensable Material (%) | | 5 × 10 − 5 torr |
| Water Vapor Regain (%) | 0.03 | 125° C. |
| Water Absorption | <0.01 | ASTM D570 |
| (%) | | |
| WVTR | 0.57 | ASTM F1249 |
| (g/100 in^{2 ·}day) | | |
| Gas Permeability, | | |
| (cc · mm/m^{2 ·} day) | | |
| N₂ | 4.8 | MOCON |
| O₂ | 23.5 | MULTI-TRAN 400 |
| CO₂ | 95.4 | |
| UV Stability (hr) | >2,000 | ASTM G154 |

In accordance with one or more embodiments of the invention, the coating can comprise a plurality of layers, each comprising a variety of polymeric materials. The plurality of layers comprising the coating can be selected to provide or impart one or more characteristics on the surface of the article. For example, the article can have a first coating that exhibits a first hydrophobic character and a second coating that exhibits a different behavior. The first and second coatings can be disposed on contiguous, adjacent, or separate portions of the surface or each other. Further, the amount or extent of coverage of the first or second coatings can vary to provide the article with a coating having a tailored behavior. Further embodiments contemplated by the invention may involve the utilization of a plurality of types of fluorinated coatings. Thus, the coated article can have a first region of its surface coated with a first fluorinated coating type and a second region, which may be disposed adjacent or contiguous with the first region, coated with a second fluorinated coating type. The coating can thus be applied, for example, to silicon carbide chips, LED clusters, silicon wafer vias and microelectromechanical systems (MEMS), and bond pads to insulate these devices or components from environmental degradation.

The parylene coating can also be used to chemically protect and reduce stiction in MEMS or components thereof. Nanotubes made with the coating may be useful in, for example, hydrogen fuel cell applications which can be utilized to selectively derive or purify hydrogen and/or otherwise facilitate the generation of electrical energy from the chemical conversion of hydrogen.

The material properties of parylene do not fluctuate greatly with changes in frequency or temperature making it a strong candidate to protect high frequency electronics such as collision avoidance systems on automobiles. The parylene coating can be applied to devices, parts and surfaces such as, for example, manifold or map sensors, diesel fuel heating elements, combustible gas or fuel level sensors, “O” rings, seals and engine gaskets, tire pressure monitoring systems, hybrid fuel system and under the hood electronics in automotive systems.

The coatings may also be disposed on electrowetting lens structures and systems thereof.

The embodiments of the invention can also have multiple applications in the medical field. The parylene coating of the invention can be advantageously utilized where it may be on devices, parts and surfaces to be uniform, biologically inert and exhibit high tensile strength. The coating adds dry film lubricity and is an excellent barrier to biofluids, chemicals and moisture. The coating may be applied to articles including stents, biochips, implantable sensors, rubber septum, catheters, mandrels and batteries. Also, flexible rubber and plastic surfaces as well as aluminum, nitinol, tungsten carbide, nickel, titanium, chrome and steel surfaces may comprise the article coated in accordance with embodiments of the present invention. Thus, the components, systems, and/or techniques of the invention may be utilized to provide a polymeric, e.g., fluorinated polymeric, material on flexible as well as rigid articles.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. Further, acts, elements, and features discussed only in connection with one embodiment are not intended to be excluded from a similar role in other embodiments. Thus although the invention discloses fluorinated polymeric materials, other halogenated polymeric materials, including copolymers with the disclosed fluorinated polymeric materials are contemplated as within the scope of the present invention. Indeed, chlorinated/fluorinated parylene copolymeric materials can be utilized as coatings of the present invention by utilizing chlorinated and fluorinated precursor dimers.

It is also to be appreciated that various alterations, modifications, and improvements can readily occur to those skilled in the art and that such alterations, modifications, and improvements are intended to be part of the disclosure and within the spirit and scope of the invention.

Those skilled in the art should appreciate that the parameters and configurations described herein are exemplary and that actual parameters and/or configurations will depend on the specific application in which the systems and techniques of the invention are used. For example, ordinarily skilled artisan would recognize that associated protective vacuum traps may be utilized in the systems and techniques of the invention. Further, those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed is:

1. A coating on at least a portion of at least one surface of an article, comprising at least one layer of a polymeric film of 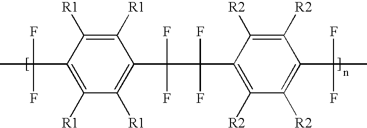
having a thickness in a range from about 500 Å to about 25 μm, where n is at least 2 and R1 and R2 is at least one of a halogen and hydrogen.

2. The coating of claim 1, wherein the article comprises an electronic device.

3. The coating of claim 1, wherein the article is an electronic device selected from the group consisting of an LED cluster, a heating element, a map sensor, a combustible gas sensor, a tire pressure monitoring system, and a fuel level sensor.

4. The coating of claim 1, wherein the article is a component of a hybrid fuel system.

5. The coating of claim 1, wherein the article is a component of an automotive electronic system, a high frequency electronic system, a microelectromechanical system, or an electrowetting lens system.

6. The coating of claim 1, wherein the article is a nanotube.

7. The coating of claim 1, wherein the article is a silicon wafer via or a wafer bond pad.

8. The coating of claim 1, wherein the article comprises an implantable medical device.

9. The coating of claim 1, wherein the article is an implantable medical device selected from the group consisting of a stent, an implantable sensor, and a catheter.

10. The coating of claim 1, wherein the article is a biochip or a component thereof.

11. The coating of claim 1, wherein R1 comprises hydrogen.

12. The coating of claim 11, wherein R2 comprises hydrogen.

13. The coating of claim 1, wherein R1 comprises fluorine.

14. The coating of claim 13, wherein R2 comprises fluorine.

15. A method of coating a surface of an article comprising:
vaporizing a fluorinated paracyclophane dimer to produce a vaporized monomeric species; and
polymerizing the monomeric species on at least a portion of the surface to produce a conformal coating comprising a polymeric material having a thickness in a range from about 500 Å to about 25 μm, the polymeric material having a formula 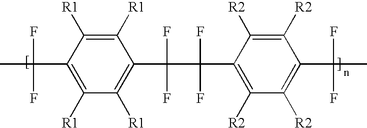
where n is at least 2 and R1 and R2 comprises hydrogen or a halogen.

16. The method of claim 15, wherein the fluorinated paracyclophane dimer is selected from the group consisting of octofluoro-[2,2]-paraxylylene and perfluoro-[2,2]-paraxylylene.

17. The method of claim 16, wherein at least one of R1 and R2 is fluorine.

18. The method of claim 17, wherein R1 and R2 is fluorine.

19. The method of claim 16, wherein at least one of R1 and R2 is hydrogen.

20. The method of claim 16, wherein the article comprises a nanoscale structure.

21. The method of claim 16, wherein the article comprises an electronic device.

22. The method of claim 16, wherein the article is an electronic device selected from the group consisting of a map sensor, a component of a tire pressure monitoring system, an LED cluster, a component of an automotive electronic system, and a component of an electrowetting lens system.

23. The method of claim 15, wherein the article comprises an implantable medical device.

24. The method of claim 15, wherein the article is a device selected from the group consisting of a stent, an implantable sensor, a biochip, and a catheter or components thereof.
